(19) United States
(12) Patent Application Publication
(10) Pub. No.: US 2007/0247057 A1
(43) Pub. Date: Oct. 25, 2007

(54) IMAGE DISPLAY DEVICE

(76) Inventors: Hajime Tanaka, Hiratsuka-shi (JP); Masaaki Inamura, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/690,514

(22) Filed: Mar. 23, 2007

Related U.S. Application Data
(63) Continuation of application No. PCT/JP05/18868, filed on Oct. 13, 2005.

(30) Foreign Application Priority Data
Oct. 15, 2004 (JP) 2004-302013

(51) Int. Cl. H01J 63/04

(52) U.S. Cl. 313/496

(57) ABSTRACT

An image display device comprises a front surface substrate equipped with a phosphor screen including a phosphor layer and a light shielding layer, and a metal back layer provided by an anode electrode for allowing electrons to collide against the phosphor layer so as to excite the phosphor layer, and a rear surface substrate arranged to face the front surface substrate and having electron releasing elements arranged thereon for allowing electrons to be released toward the phosphor screen. The image display device is characterized in that an anode power supply terminal and an anode power supply wiring connected to the metal back layer are formed on the front surface substrate, the anode power supply wiring is formed closer to the front surface substrate than the metal back layer, and the anode power supply wring is connected to the metal back layer via a resistance material layer.

### CROSS-REFERENCE TO RELATED APPLICATIONS

This is a Continuation Application of PCT Application No. PCT/JP2005/018868, filed Oct. 13, 2005, which was published under PCT Article 21(2) in Japanese.

This application is based upon and claims the benefit of priority from prior Japanese Patent Application No. 2004-302013, filed Oct. 15, 2004, the entire contents of which are incorporated herein by reference.

### BACKGROUND OF THE INVENTION

1. Field of the Invention

The present invention relates to an image display device, particularly, to an image display device that is constructed such that the front surface substrate side having a fluorescent screen or a metal back layer formed thereon has been improved so as to improve the brightness of the image display device.

2. Description of the Related Art

In recent years, a planar image display device in which a large number of electron releasing elements are arranged to face the image display screen is being developed as a next era image display device. There are various electron releasing elements. Any of these electron releasing elements utilizes in principle the electron release achieved by the electric field. The image display device utilizing these electron releasing elements is called in general a field emission display (hereinafter referred to as FED). The FED includes an image display device using a surface conduction type electron releasing element, which is called a surface conduction type electron release display (hereinafter referred to as SED). The term FED denotes a broad concept including SED.

FED includes in general a front surface substrate and a rear surface substrate. These front surface substrate and the rear surface substrate are arranged to face each other with a prescribed free space given therebetween. The peripheral edge portions of these front surface and rear surface substrates are bonded to each other via a rectangular frame-like side wall so as to form a vacuum envelope. The inner space of the vacuum envelope is maintained at a high vacuum of about 10⁻⁴ Pa or less. Also, since the atmospheric load applied to the rear surface substrate and the front surface substrate are supported, a plurality of support members are arranged between the rear surface substrate and the front surface substrate.

A phosphor screen including phosphor layers emitting red, blue and green lights and a light shielding layer is formed on the inner surface of the front surface substrate. Also, in order to obtain practical display characteristics, an aluminum thin film that is called a metal back layer is formed on the phosphor screen. Further, in order to permit the gas remaining inside the vacuum envelope and the gas released from each of the substrates such as a hydrogen gas, a methane gas, an oxygen gas, a carbon dioxide gas or a water vapor to be adsorbed, a metal thin film that is called a getter layer and capable of exhibiting the gas adsorbing characteristics is formed by the vapor deposition method on the metal back layer. The thin metal film noted above is formed of, for example, barium (Ba), vanadium (V), titanium (Ti), or Ta (tantalum).

A large number of electron releasing elements are formed on the inner surface of the rear surface substrate for releasing electrons serving to excite the phosphor for emitting light. Also, a large number of scanning lines and signal lines, which are formed in the shape of a matrix, are connected to the electron releasing elements.

In the FED of the construction described above, an anode voltage is applied to the image display screen including a phosphor layer and a metal back layer. The electron beam emitted from the electron releasing element is accelerated by the anode voltage, with the result that the accelerated electron beam is allowed to collide against the phosphor screen, thereby causing the phosphor to emit light. As a result, an image is displayed on the image display screen. In this case, it is desirable for the anode voltage to be at least about several kV or, if possible, not lower than 10 kV.

In the FED of the construction described above, it is possible for the clearance between the front surface substrate and the rear surface substrate to be set at about several millimeters so as to make it possible to decrease markedly the weight and the thickness of the display, compared with the cathode ray tube (CRT) used nowadays as the display in a TV receiver or a computer.

In recent years, damages done to the phosphor screen and the electron source, which are caused by the large current of several hundred amperes accompanying the discharge, have come to attract attentions in the display of the vacuum type such as the FED in accordance with acceleration in the development of the thin display. To be more specific, proposed in patent document 1 given below is an image display device comprising a means for alleviating the peak current value by forming the metal back layer in the shape of strips having small areas and connected to each other to have a resistance value of several hundred KΩ. In this prior art, the edge of the metal back layer is connected to the anode supply terminal so as to decrease the flowing speed of the current flowing into the discharge area of the anode, thereby alleviating the peak current value.

Patent Document 1: Japanese Patent Disclosure No. 2003-242911

### BRIEF SUMMARY OF THE INVENTION

In the image display device described above, however, the power supply to the anode is made insufficient if a defect such as breakage is included in the metal back layer or if the metal back layer is broken by the damage caused by the discharge so as to give rise to the problem that a dark line having a low brightness is generated. The problem is rendered serious if the longer side of the strip-like metal back layer is increased with increase in the area of the image display device.

An object of the present invention, which is intended to overcome the drawbacks described above, is to provide an image display device, which permits suppressing the peak value of the discharge current so as to prevent the discharge current from applying a large load to the anode supply wiring and which permits preventing the power supply to the anode from being delayed even if there is a defect such as breakage on the metal back layer so as to allow the image display device to maintain a sufficient brightness.

In order to achieve the object described above, a first aspect of the present invention provides an image display device, comprising a front surface substrate equipped with a phosphor screen including a phosphor layer and a light shielding layer, and a metal back layer provided by an anode electrode superposed on the phosphor screen for allowing electrons to collide against the phosphor layer so as to excite the phosphor layer; and a rear surface substrate arranged to face the front surface substrate and having electron releasing elements arranged thereon for allowing electrons to be released toward the phosphor screen; characterized in that an anode power supply terminal and an anode power supply wiring connected to the metal back layer are formed on the front surface substrate, the anode power supply wiring is formed closer to the front surface substrate than the metal back layer, and the anode power supply wring is connected to the metal back layer via a resistance material layer.

The image display device according to the present invention permits performing the power supply to the anode on the lattice-shaped surface. As a result, it is possible to prevent the voltage drop and to maintain a sufficient brightness even if there is a defect such as breakage in the metal back layer. Also, since the anode power supply wiring is connected to the metal back layer via a resistance material layer having a relatively large area, a resistance material having a high sheet resistance, which is formed into a thin film, can also be used as a material of the resistance material layer. It follows that the width of choice of the material is broadened.

### BRIEF DESCRIPTION OF THE SEVERAL VIEWS OF THE DRAWING

FIG. 1 is an oblique view schematically exemplifying the construction of an FED according to one embodiment of the present invention;

FIG. 2 schematically shows a cross-sectional construction of the FED along the line II-II shown in FIG. 1;

FIG. 3 shows the construction of the front surface substrate forming a constituent of the FED shown in FIG. 1;

FIG. 4 shows the construction of the FED shown in FIG. 1, covering the case where a light shielding layer, which also acts as an anode power supply wiring, is formed to constitute at least the lowermost layer of the front surface substrate, and a resistance material layer is formed to cover the light shielding layer;

FIG. 5 shows the construction of the FED shown in FIG. 1, covering the case where an anode power supply wiring is stacked on at least a part of the light shielding layer, and a resistance material layer is formed to surround the anode power supply wiring;

FIG. 6 shows the construction of the FED shown in FIG. 1, covering the case where an anode power supply wiring is arranged on a striped portion forming a part of the striped portion that is parallel to the x-direction of the light shielding layer, a resistance material layer having an area larger than at least the installing area of the metal back layer is arranged on the anode power supply wiring, and the metal back layer is electrically divided into a plurality of regions in a portion where the striped portion of the anode power supply wiring, which is parallel to the x-direction of the light shielding layer, is not stacked;

FIG. 7 is a plan view showing the state that a light shielding layer is formed on the front surface substrate;

FIG. 8 is a plan view showing the state that an anode power supply wiring is formed on the light shielding layer shown in FIG. 7;

FIG. 9 is a plan view showing the state that a resistance material layer is formed on the anode power supply wiring shown in FIG. 8;

FIG. 10 is a plan view showing the state that an aluminum back layer that is divided in the direction of the y-axis is formed on the phosphor layer and on the resistance material layer shown in FIG. 9; and

FIG. 11 is a plan view showing the state that the aluminum back layer shown in FIG. 10 is further divided in the direction of the x-axis.

### DETAILED DESCRIPTION OF THE INVENTION

An image display device according to one embodiment of the present invention will now be described with reference to the accompanying drawings. In the following description, an FED equipped with an electron releasing element of a surface conduction type is taken up as an example of the image display device according to the embodiment of the present invention.

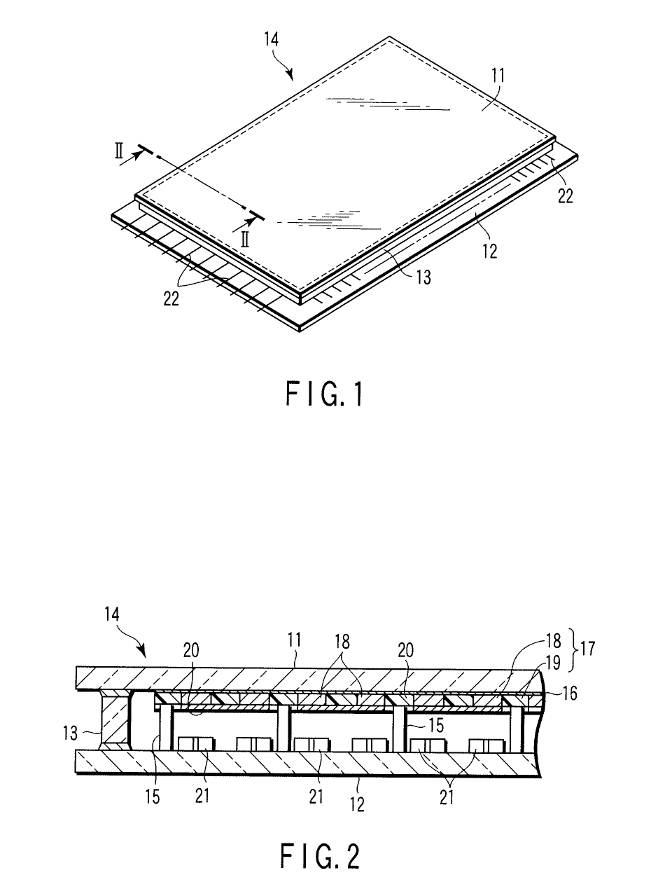

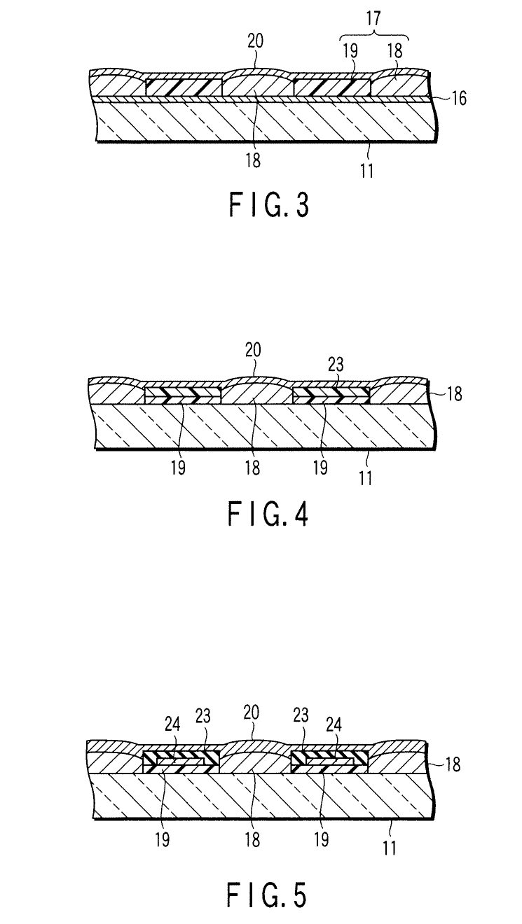

The entire construction of the FED will now be described first with reference to FIGS. 1, 2 and 3, wherein FIG. 1 is an oblique view schematically exemplifying the construction of the FED according to the embodiment of the present invention; FIG. 2 schematically shows a cross sectional construction of the FED along line II-II shown in FIG. 1; and FIG. 3 shows the construction of the front surface substrate forming a constituent of the FED shown in FIG. 1.

As shown in FIGS. 1 and 2, the FED comprises a front surface substrate 11 and a rear surface substrate 12, which are arranged to face each other with a clearance of several millimeters provided therebetween. Each of the front surface substrate 11 and the rear surface substrate 12 includes an insulating substrate formed of a rectangular glass plate having a thickness of 1 to 3 mm. The peripheral portion of the front surface substrate 11 is bonded to the peripheral portion of the rear surface substrate 12 via a rectangular frame-like side wall 13 so as to form a flat and rectangular vacuum envelope 14 having the inner region maintained at a high vacuum of about 10⁻⁴ Pa.

A plurality of spacers 15 are arranged within the vacuum envelope 14 so as to permit the spacers 15 to support the atmospheric load applied to the front surface substrate 11 and to the rear surface substrate 12. It is possible for the spacer 15 to be shaped plate-like or to be shaped columnar.

A phosphor screen 17 is formed on the inner surface of the front surface substrate 11 with a transparent electron conducting film 16 interposed therebetween. The transparent electron conducting film 16 noted above functions as an anode power supply wiring. Also, an anode power supply terminal (not shown) that is connected to the transparent electron conducting film 16 is connected to the inner surface of the front surface substrate 11. The phosphor screen 17 comprises phosphor layers 18 formed on the front surface substrate 11 and emitting light rays of red (R), green (G) and blue (B) and light absorbing layers (light shielding layers) 19 each having at least a part acting as a resistance layer. The phosphor layers 18 and the light absorption layers 19 are arranged to form a matrix. It should be noted that the resistance of that portion of the light shielding layer which acts as the resistance layer is set at 1×10² to 1×10⁷Ω.

A metal back layer 20 functioning as an anode electrode is formed on the phosphor screen 17 in the shape of, for example, strips. The phosphor layer 18 is formed in the shape of, for example, dots. The metal back layer 20 is formed of, for example, an aluminum thin film in the form of a plurality of regions that are electrically separated from each other. The method of forming the metal back layer 20 in the form of a plurality of regions that are electrically separated from each other is disclosed in, for example, patent document 1 quoted previously. To be more specific, it is disclosed that the metal back layer is formed by the vapor deposition method. In this case, masking is applied by using, for example, a metal mask, so as to form a strip-like metal back layer of a prescribed separation pattern. It is also taught that a metal back layer is formed on the entire pixel region, followed by separating the metal back layer by utilizing a laser beam. The method of electrically separating the metal back layer is also disclosed in, for example, Japanese Patent Disclosure No. 2002-343241 (patent document 2). It is taught that a metal back layer is formed on the entire pixel region, followed by coating a prescribed region of the metal back layer with a liquid material that oxidizes the metal back layer so as to form a metal oxide layer having a high resistance, thereby electrically separating the metal back layer into a plurality of separated regions. It is possible to employ any desired method in the present invention for forming a metal back layer that is electrically separated into a plurality of regions. In other words, it is not absolutely necessary to employ any of the methods exemplified above for forming the metal back layer that is electrically separated into a plurality of regions.

The rear surface substrate 12 comprises a surface conduction type electron releasing element 21 that is arranged on the inner surface. The electron releasing element 21 performs the function of an electron source serving to excite the phosphor layer 18 included in the phosphor screen 17. To be more specific, a plurality of electron releasing elements 21 are arranged on the rear surface substrate 12 in a manner to form a plurality of columns and a plurality of rows for each pixel so as to release electron beams toward the phosphor layers 18. Each of the electron releasing elements 21 comprises an electron releasing section (not shown) and a pair of element electrodes for applying voltage to the electron releasing section. Also, in order to supply potential to the electron releasing element 21, a large number of wirings 22 are arranged on the inner surface of the rear surface substrate 12 in a manner to form a matrix. As shown in FIG. 1, the edge portions of the wirings 22 are withdrawn to the outside of the vacuum envelope 14.

In operating the FED of the construction described above, an anode voltage is applied to the image display section including the phosphor screen 17 and the metal back layer 20 so as to display the image. The electron beam released from the electron releasing element 21 is accelerated by the anode voltage so as to permit the accelerated electron beam to collide against the phosphor screen 17. As a result, the phosphor layer 18 included in the phosphor screen 17 is excited so as to emit light of the corresponding color. In this fashion, a color image is displayed on the image display screen.

In the present invention, the relationship between the anode power supply wiring and the metal back layer is not limited to that shown in FIG. 3. In addition, it is also possible for the apparatus to be constructed as in cases 1) to 3) given below:

1) As shown in FIG. 4, formed is a light shielding layer 19. At least a part of the light shielding layer 19 performs the function of an anode power supply wiring. Also, a resistance material layer 23 having a resistance of 1×10² to 1×10⁷Ω is formed to cover the light shielding layer 19. The anode power supply terminal connected to the anode power supply wiring is connected to the inner surface of the front surface substrate 11. Also, the light shielding layer 19 performing the function of the anode power supply wiring and the metal back layer 20 are arranged to face each other with the resistance material layer 23 interposed therebetween.

2) As shown in FIG. 5, an anode power supply wiring 24 is stacked on at least a part of the light shielding layer 19, and a resistance material layer 23 having the resistance of 1×10² to 1×10⁷Ω is stacked to surround the anode power supply wiring 24. Incidentally, the anode power supply wiring 24 and the metal back layer 20 are arranged on the inner surface of the front surface substrate 11 in a manner to face each other with the resistance material layer 23 interposed therebetween.

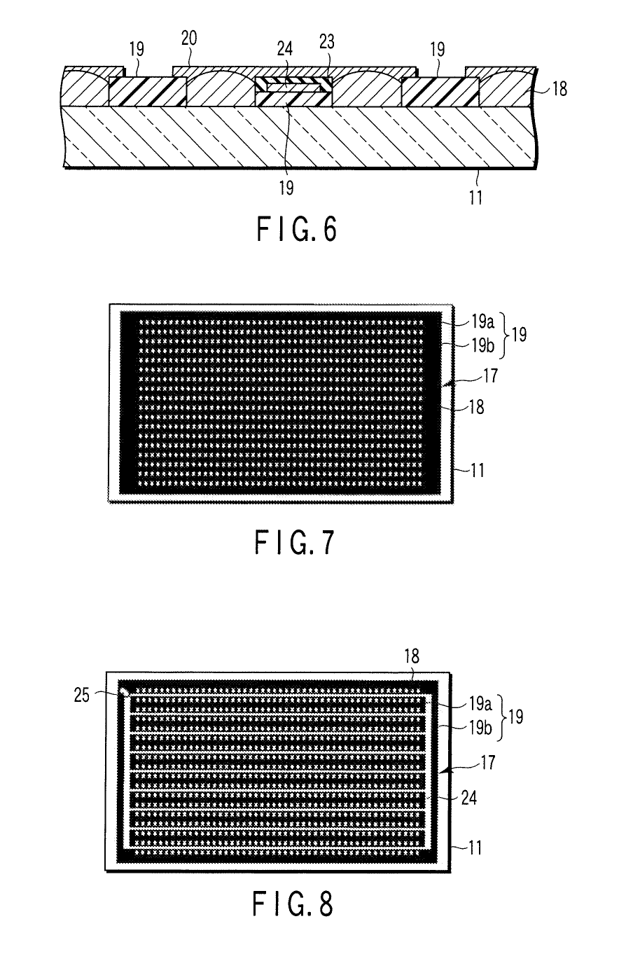

3) As shown in FIG. 6, an anode power supply wiring 24 is stacked in a striped fashion on at least a part of the striped portion that is parallel to the x-direction of the light shielding layer 19, i.e., a direction perpendicular to the paper. In this case, all the anode power supply wirings 24 and the anode power supply terminals are electrically connected to each other in the outer peripheral portion of the effective pixel portion. In addition, the resistance material layer 23 is arranged on the anode power supply wiring 24 in a range larger than at least the installing area of the metal back layer. Further, the metal back layer 20 is electrically separated into a plurality of regions in at least a part of the portion where a striped anode power supply wiring, which is parallel to the x-direction of the light shielding layer 19, is not formed.

It is possible for the anode power supply wiring 24 to be arranged not only in a portion parallel to the x-direction of the light shielding layer 19 but also in a portion parallel to the y-direction of the light shielding layer 19. Also, it is possible for the metal back layer to be electrically separated in a portion where the metal back layer is not stacked on a portion where a striped anode power supply wiring parallel to the x-direction of the light shielding layer 19 is not formed. It is also possible for the metal back layer to be electrically separated in a portion of the metal back layer in which a striped anode power supply wiring parallel to the x-direction of the light shielding layer 19 and the resistance material layer are stacked one upon the other as far as the metal back layer is connected even if partly to the anode power supply wiring via the resistance layer. Further, it is also possible for the metal back layer to be electrically separated in a part of a first portion where the metal back layer is stacked on a portion parallel to the x-direction of the light shielding layer 19 and a second portion where the metal back layer is stacked on a portion parallel to the y-direction of the light shielding layer 19.

In the present invention, it is desirable for the resistance material layer to have a resistance falling within a range of 1×10² to 1×10⁷Ω. If the resistance material layer has a resistance lower than 1×10²Ω, it is difficult to suppress the discharge current. On the other hand, if the resistance of the resistance material layer has a resistance exceeding 1×10⁷Ω, the voltage drop is excessively increased so as to lower the brightness of the phosphor screen. Also, it is desirable for the region between the dot-like separated metal back layers to have a resistance not lower than 1×10²Ω. If the resistance in question is lower than 1×10²Ω, it is difficult to suppress the discharge current.

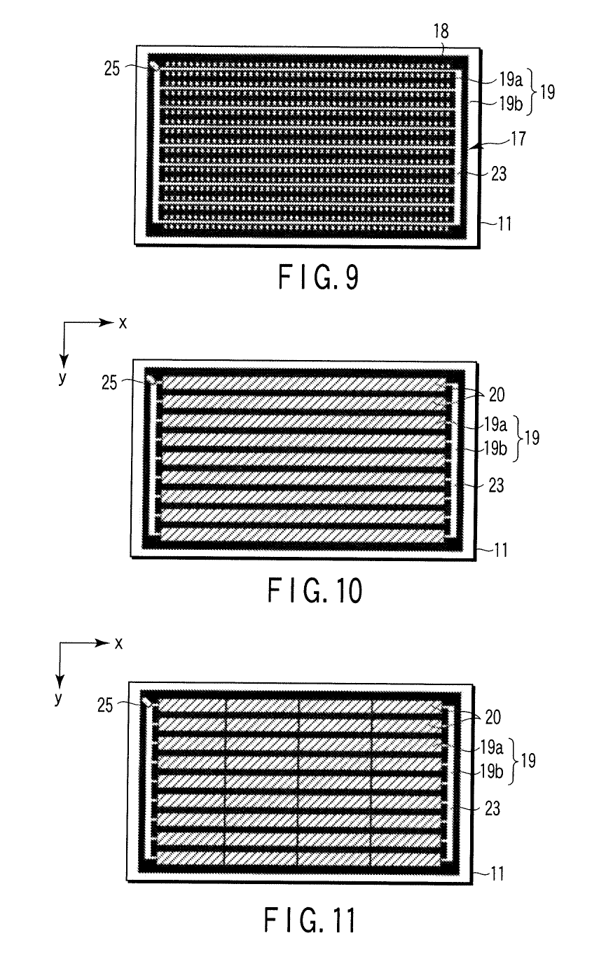

In the present invention, the anode power supply wiring and the metal back layer are formed as shown in, for example, FIGS. 7 to 11. In the first step, the phosphor layer 18 emitting light rays of red (R), green (G) and blue (B) is formed on the inner surface of the front surface substrate 11. Also formed on the inner surface of the front surface substrate 11 is a light shielding layer 19 arranged in the form of a matrix. The light shielding layer 19 comprises a large number of striped portions 19a arranged in parallel a prescribed distance apart from each other and a rectangular frame portion 19b extending along the periphery of the phosphor screen 17. In the next step, a ladder-shaped anode power supply wiring 24 and an anode power supply terminal 25, which is connected to the anode power supply wiring 24, are connected to the light shielding layer 19, as shown in FIG. 8, followed by forming a resistance material layer 23 on the anode power supply wiring 24, as shown in FIG. 9. Further, a striped metal back layer 20 that is separated in the direction of the y-axis is formed on the resistance material layer 23 and the phosphor layer 18, as shown in FIG. 10, followed by separating the metal back layer 20 in the x-direction, too, so as to form a dot-like metal back layer 20 bestriding a plurality of phosphor layers, as shown in FIG. 11.

According to the image display device of the present invention, the anode power supply terminal 25 and the anode power supply wiring 24 connected to the metal back layer 20 are formed on the front surface substrate 11 on the side of the front surface substrate. Also, the anode power supply wiring 24 is formed closer to the front surface substrate than the metal back layer, and the anode power supply wiring 24 is connected to the metal back layer 20 via a resistance material layer. In other words, the power supply to the anode is performed by the lattice-like plane so as to make it possible to prevent the voltage drop even if a defect such as separation is included in the metal back layer 20. It should also be noted that the anode power supply wiring 24 is connected to the metal back layer 20 via a resistance material layer having a relatively large area. It follows that it is possible to use a material having a high sheet resistance as a material of the resistance material layer if the material having a high sheet resistance is formed into a thin film for forming the resistance material layer. It follows that the width of selection of the material can be broadened.

Specific examples of the present invention will now be described. The examples given below cover that portion alone which is on the side of the front surface substrate. The other portion is equal in function to the members shown in FIGS. 1 and 2 and, thus, the description thereof is omitted.

### EXAMPLE 1

FIG. 3 shows the construction of the image display device for Example 1. The phosphor screen 17 is formed on the inner surface of the front surface substrate 11 made of glass. An ITO transparent electron conductive film 16 having a thickness of 200 nm, which performs the function of an anode power supply wiring, is formed between the front surface substrate 11 and the phosphor screen 17. Also, an anode power supply terminal (not shown), which is connected to the transparent electron conductive film 16, is connected to the inner surface of the front surface substrate 11. The phosphor screen 17 comprises phosphor layers 18 emitting light rays of red (R), green (G) and blue (B) and a light absorption layer (light shielding layer) 19 having a thickness of 10 μm, arranged in the form a matrix and including at least a part that acts as a resistance material layer. The resistance of the light shielding layer 19 that acts as the resistance material layer is set at about 1×10⁴Ω. Further, a metal back layer 20 having a thickness of 80 nm and made of aluminum is formed in the form of a strip on the phosphor screen 17.

According to the image display device for Example 1, the anode power supply terminal and the transparent electron conductive film (anode power supply wiring) 16 connected to the metal back layer 20 are formed on the front surface substrate 11. Also, the anode power supply wiring 16 is formed closer to the front surface substrate 11 than the metal back layer 20, and the anode power supply wiring 16 is connected to the metal back layer 20 via a light shielding layer (resistance material layer) 19. In other words, the power supply to the anode is performed by the lattice-like plane so as to make it possible to prevent the voltage drop even if a defect such as separation is included in the metal back layer 20. It should also be noted that the anode power supply wiring 16 is connected to the metal back layer 20 via a resistance material layer 19 having a relatively large area. It follows that it is possible to use a material having a high sheet resistance as a material of the resistance material layer if the material having a high sheet resistance is formed into a thin film for forming the resistance material layer. It follows that the width of selection of the material can be broadened.

### EXAMPLE 2

As shown in FIG. 4, the image display device for Example 2 comprises a light shielding layer 19 having a thickness of 5 nm and including at least a part which acts as an anode power supply line and a resistance material layer 23 having a thickness of 10 μm and a resistance of about 1×10⁴Ω. The resistance material layer 23 is formed to cover the light shielding layer 19. Incidentally, the anode power supply terminal (not shown), which is connected to the light shielding layer 19 acting as the anode power supply wiring, is connected to the inner surface of the front surface substrate 11. The light shielding layer 19 and the metal back layer 20 are arranged to face each other with the resistance material layer 23 interposed therebetween.

The image display device for Example 2 produces effects similar to those produced by the image display device for Example 1.

### EXAMPLE 3

As shown in FIG. 5, the image display device for Example 3 comprises an anode power supply wiring 24 having a thickness of 5 μm. The anode power supply wiring 24 is stacked on at least a part of the light shielding layer 19. Further, a resistance material layer 23 having a thickness of 10 μm and a resistance of about 1×10⁴Ω is stacked in a manner to surround the anode power supply wiring 24. Incidentally, the anode power supply terminal (not shown), which is connected to the anode power supply wiring 24, is connected to the inner surface of the front surface substrate 11. Further, the anode power supply wiring 24 and the metal back layer 20 are arranged to face each other with the resistance material layer 23 interposed therebetween.

The image display device for Example 3 produces effects similar to those produced by the image display device for Example 1.

### EXAMPLE 4

As shown in FIG. 6, the image display device for Example 4 comprises an anode power supply wiring 24 arranged in a striped portion in a part of the striped portion parallel to the x-direction of the light shielding layer 19 having a thickness of 1 μm. In this case, all the lines and anode power supply terminals are electrically connected at the outer peripheral portion, and a resistance material layer 23 is arranged on the anode power supply wiring 24 in a range larger than at least the installing area of the metal back layer. Further, the metal back layer 20 is electrically separated into a plurality of regions in the portion where the anode power supply wiring is not stacked in a striped portion parallel to the x-direction of the light shielding layer 19.

The image display device for Example 4 produces effects similar to those produced by the image display device for Example 1.

Incidentally, the present invention is not limited to the Examples themselves described above. In embodying the technical idea of the present invention, it is possible to modify the constituting factors of the present invention within the technical scope of the present invention. It is also possible to arrive at various inventions by the appropriate combination of the plural constituting factors disclosed in the embodiments described above. For example, it is possible to delete some constituting factors from all the constituting factors disclosed in the embodiments described above. Further, it is possible to combine appropriately the constituting factors included in different embodiments of the present invention so as to arrive at a different invention.

What is claimed is:

1. An image display device, comprising:
a front surface substrate equipped with a phosphor screen including a phosphor layer and a light shielding layer, and a metal back layer provided by an anode electrode superposed on the phosphor screen for allowing electrons to collide against the phosphor layer so as to excite the phosphor layer; and
a rear surface substrate arranged to face the front surface substrate and having electron releasing elements arranged thereon for allowing electrons to be released toward the phosphor screen;
wherein an anode power supply terminal and an anode power supply wiring connected to the metal back layer are formed on the front surface substrate, the anode power supply wiring is formed closer to the front surface substrate than the metal back layer, and the anode power supply wring is connected to the metal back layer via a resistance material layer.

2. The image display device according to claim 1, wherein the resistance between the anode power supply wiring and the metal back layer falls within a range of 1×10² to 1×10⁷Ω.

3. The image display device according to claim 1 or claim 2, wherein the anode power supply wiring is formed of a transparent electron conductive film formed to constitute the lowermost layer of the front surface substrate and capable of transmitting a visible light, and at least a part of the light shielding layer formed on the transparent electron conductive film also acts as the resistance material layer.

4. The image display device according to claim 1, wherein the anode power supply wiring is formed to act also as at least a part of the light shielding layer, and the resistance material layer is formed on the anode power supply wiring.

5. The image display device according to claim 2, wherein the anode power supply wiring is formed to act also as at least a part of the light shielding layer, and the resistance material layer is formed on the anode power supply wiring.

6. The image display device according to claim 1, wherein the anode power supply wiring is stacked on at least a part of the light shielding layer, and the resistance material layer is formed on the anode power supply wiring.

7. The image display device according to claim 2, wherein the anode power supply wiring is stacked on at least a part of the light shielding layer, and the resistance material layer is formed on the anode power supply wiring.

8. The image display device according to any one of claims 1 to 7, wherein:
the light shielding layer is formed on the front surface substrate in the form of a matrix, and a phosphor layer forming a single pixel or a plurality of pixels is formed in a region surrounded by the light shielding layer;
a striped and stacked anode power supply wiring is arranged in at least a part of one of the striped portion parallel to the x-direction of the light shielding layer arranged in the form of a matrix and the striped portion parallel to the y-direction of the light shielding layer arranged in the form of a matrix, all the anode power supply wirings and the anode power supply terminals are electrically connected at the outer peripheral portion of the effective pixel portion, a resistance material layer is arranged on the anode power supply wiring in a range lager than at least the installing area of the metal back layer, and the metal back layer is connected to the anode power supply wiring via the resistance material layer; and
the metal back layer is electrically separated into a plurality of regions in at least one of the portion stacked on the striped portion parallel to the x-direction of the light shielding layer arranged in the form of a matrix and the portion stacked on the striped portion parallel to the y-direction of the light shielding layer arranged in the form of a matrix.

9. The image display device according to claim 8, wherein the resistance between the separated metal back layers is not lower than 1×10²Ω.
